(19) United States
(12) Patent Application Publication
(10) Pub. No.: US 2014/0300463 A1
(43) Pub. Date: Oct. 9, 2014

(54) Multiple Color Hazard Warning/Signaling Device for Trailing End of Trunk Lid

(71) Applicant: Derek Terrell Russ, (US)

(72) Inventor: Derek Terrell Russ, Gretna, LA (US)

(21) Appl. No.: 13/858,072

(22) Filed: Apr. 7, 2013

(51) Int. Cl. B60Q 1/46

(52) U.S. Cl. CPC B60Q 1/46
USPC 340/471

(57) ABSTRACT

The present invention generally relates to an improved hazard warning/signaling device, more particularly, to a multiple color hazard warning/signaling device for trailing end of trunk lid for a vehicle(s) which becomes temporarily effective upon activation of the vehicle's remote trunk release, which places the device in a displayed position for other highway vehicles, and upon engagement of the vehicle's hazard flashing system, or the like. The device includes multiple light emitting diodes (LEDs) configured to emit different colors, or one color, through a single optical lens. This present invention enhances the safety of the vehicle by combining the advantages of a hazard flashing system into the multiple color hazard warning/signaling device for trailing end of trunk lid and cooperates to increase overall vehicle safety creating a synergistic effect.

### CROSS-REFERENCE TO RELATED APPLICATIONS

This application claims the benefit of provisional patent application No. 61/717,426, filed 2012 Oct. 23 by the present inventor.

### BACKGROUND—DESCRIPTION OF PRIOR ART

The present invention generally relates to an improved hazard warning/signaling device, more particularly, to a multiple color hazard warning/signaling device for trailing end of trunk lid for a vehicle(s) which becomes temporarily effective upon activation of the vehicle's remote trunk release, which places the device in a displayed position for other highway vehicles, and upon engagement of the vehicle's hazard flashing system, or the like. The device includes multiple light emitting diodes (LEDs) configured to emit different colors, or one color, through a single optical lens. This present invention enhances the safety of the vehicle by combining the advantages of a hazard flashing system into the multiple color hazard warning/signaling device for trailing end of trunk lid and cooperates to increase overall vehicle safety creating a synergistic effect.

There are known hazard warning/signaling devices for use on vehicles, an example of which is the aforementioned hazard flashing system, in which emergency light flashers are attached to the lower portions of a vehicle. A disadvantage of this type of warning device is that it is not easily seen in the day time and can be readily obstructed by persons standing on the road working around the vehicle. Other known hazard warning/signaling devices have included reflective triangles, flashing lights or beacons, strobe lights, and flashing or sequentially illuminated directional arrows.

The present invention becomes an essential safety alert when the vehicle stands on any road, in the way of an on-coming vehicle, where there may be danger of collision with said on-coming vehicle, and danger of personal injury to the occupant of said on-coming vehicle. The device can be quickly and easily withdrawn by closing the vehicle's trunk lid and deactivating the vehicle's hazard flashing system. The multiple color hazard warning/signaling device for trailing end of trunk lid can be mounted by new car, van and sports utility vehicles manufacturers as original, standard or upgrade equipment. The device can also be made available in an aftermarket kit form for installation by individual purchasers. Preferably, the device is lightweight, affordable and adaptable to a wide variety of cars, vans and sports utility vehicles.

It is well known to use visual light signals on passenger, police, fire, emergency, and medical service vehicles, or the like for increasing the visibility of these vehicles to motorists and pedestrians in emergency and traffic control situations. One of the most common types of light signals is a light bar. Light bars are typically mounted to the exterior roof or top of the emergency or law enforcement vehicles. Alternatively, light bars may be mounted within the interior of these vehicles such that they are visible through the front, side or rear windows.

All safety and law enforcement vehicles have enjoyed safety features of hazard lights that are substantially visible on roads and highways. Personal motor vehicles should also enjoy these safety features in a practical manner, although it would not be an aesthetically appeasing and a commercially successful design element if vehicle designers were to design hazard lights in the same manner as an external component of the vehicle's design, excepting lights that motor vehicles currently utilize.

### OBJECTS AND SUMMARY

The above-mentioned and other problems become solved by applying the principles and teachings associated with the hereinafter described multiple color hazard warning/signaling device for trailing end of trunk lid. An added, practical, and easy to employ multiple color hazard warning/signaling device for trailing end of trunk lid would enhance a hazard flashing system of any vehicle and is of a size and character to be visible at a great distance.

The present invention relates to warning/signaling lights for vehicles, such as passenger, police, fire, emergency, and medical service vehicles. The present invention provides a multiple color hazard warning/signaling device for trailing end of trunk lid adapted for mounting within, or adjacent to, the trailing end of the trunk lid that can be utilized to direct traffic. The device includes multiple light emitting diodes configured to emit different colors, or one color, through a single optical lens.

In a basic sense, the multiple color hazard warning/signaling device for trailing end of trunk lid includes a plurality LEDs aligned in a single row. Each of the plurality of LEDs are configured to emit two different colors of light-red and/or amber-through a single optical lens. As a result, the multiple color hazard warning/signaling device for trailing end of trunk lid is capable of producing a single light color red, a single color amber, and/or dual light colors red and amber when the vehicle's hazard flashing system, or the like, is engaged. For example, the multiple color hazard warning/signaling device for trailing end of trunk lid illuminates red and/or amber colors upon engagement of the vehicle's hazard flashing system in a warning/emergency mode or traffic directional mode, such as “arrow stick” configuration.

Advantageously, a passenger, or an emergency, vehicle may be equipped with a multiple color hazard warning/signaling device for trailing end of trunk lid, which is capable of displaying multiple colors and patterns to provide enhanced vehicle and passenger safety.

In one embodiment, the multiple color hazard warning/signaling device for trailing end of trunk lid has a housing. The housing has a plurality of transparent modules that are equally positioned adjacent to each other along the length of the housing. Each module includes a plurality of LED packages and a secondary optic lens, which is typically used with high powered LEDs to narrow down the angle of light output and project the light outwards. Each LED package includes an individual diode, two light emitting chips, a set of leads connecting the individual diode to the light emitting chips and a primary optical lens. The LED packages as well as the individual diodes are aligned side-by-side creating a single row within any particular module. Each individual diode in the LED package will produce a light in a first color and/or a second color when properly biased. To appropriately bias the individual diode, a drive signal from one of the pair of LED chips is sent through the leads to trigger the individual diode to produce a desired color.

Still other objects of the present invention will become apparent to those skilled in the art from the following description wherein there is shown and described a preferred embodiment of this invention, simply by way of illustration of one of the modes best suited to carry out the invention. As it will be realized, the invention is capable of other different embodiments and its several details are capable of modification in various and obvious aspects, all without departing from the invention. Accordingly, the drawings and description will be regarded as illustrative in nature and not as restrictive.

### BRIEF DESCRIPTION OF THE DRAWINGS

FIG. 1 shows a rear perspective view in accordance with one embodiment of the present invention;

FIG. 2 shows a top view in accordance with one embodiment of the present invention;

FIG. 3 shows a left side view in accordance with one embodiment of the present invention;

FIG. 4 shows a left side view in accordance with one embodiment of the present invention;

FIG. 5 shows a front view in accordance with one embodiment of the present invention;

FIG. 6 shows a front view in accordance with one embodiment of the present invention of individual modules;

FIG. 7a shows a top view in accordance with one embodiment of the present invention of an individual module;

FIG. 7b shows a top view in accordance with one embodiment of the present invention;

FIG. 8 shows a front view in accordance with one embodiment of the present invention of an individual module;

FIG. 9 shows a block diagram showing the principles of the present invention; and

FIG. 10 shows a front view in accordance with one embodiment of the present invention of an input device.

Reference Numerals

10 multiple color hazard warning/signaling
device for trailing end of trunk lid
12 Signal Indicator
14 Housing
16 LED Package
18 Light Emitting Chip
20 Light Emitting Chip
22 Primary Optical Lens
24 Secondary Optical Lens
26 Operating Device or Controller
28 Battery
30 Input Device
32 Input Button
34 Input Button
36 Input Button
38 Plurality of LEDs
40 Attachment Means
42 Hazard Flasher System Button
44 Vehicle
46 Trunk Lid
46a Upper Flat Portion
46b Rear Bent Portion
46b′ Leading End
48 Inner Panel
50 Outer Panel
52 Laterally Extending Slot
54 Endless Sealing Thread
56 Bumper
58 Normally-on Brake Lights

### EMBODIMENTS—DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process or other changes may be made without departing from the scope of the present invention. The following detailed description is, thus, not to be taken in a limiting sense.

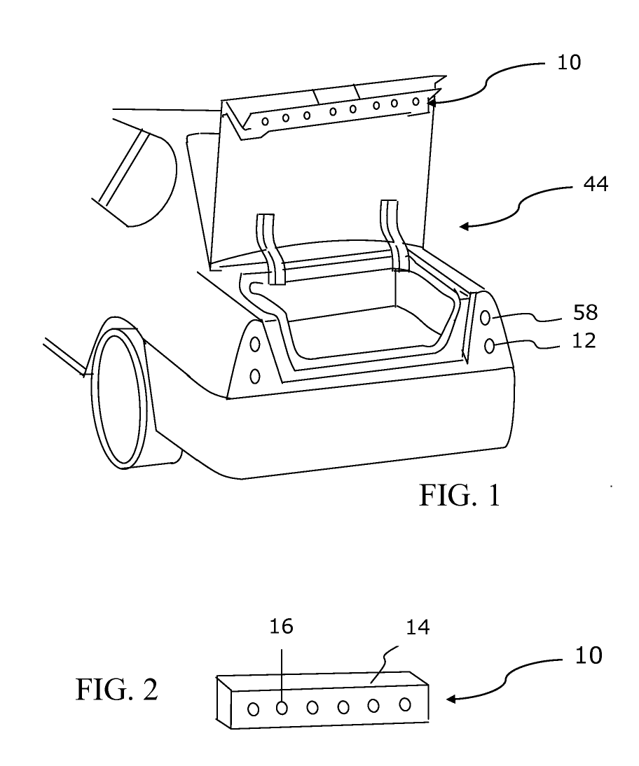

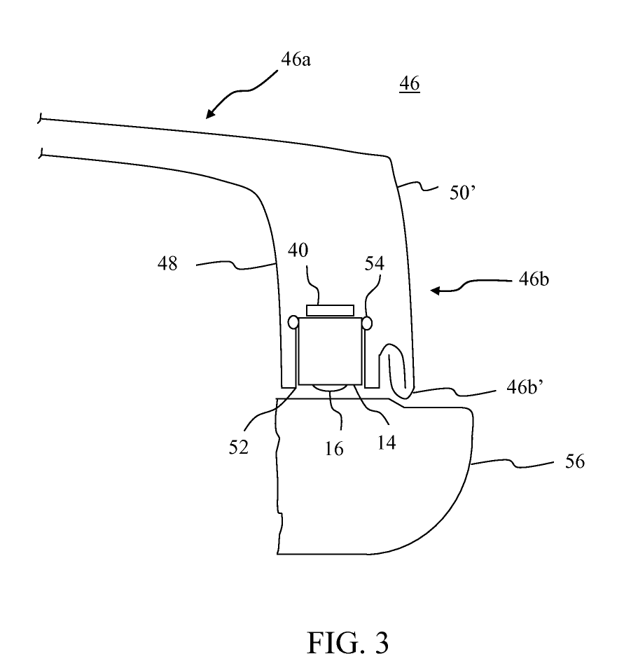

As best perhaps best illustrated in FIG. 1, the present invention relates to a multiple color hazard warning/signaling device for trailing end of trunk lid 10. Specifically, the multiple color hazard warning/signaling device for trailing end of trunk lid includes a housing 14 and provides external illumination to other motorists and pedestrians. FIG. 2. There is shown a rear bent part of a trunk lid to which a trunk lid hazard warning/signaling device 10 is mounted in a manner to embody the present invention. FIG. 3. In addition to passenger vehicles, the multiple color hazard warning/signaling device for trailing end of trunk lid 10 may be used in conjunction with law enforcement vehicles, other emergency vehicles, tow trucks or the like.

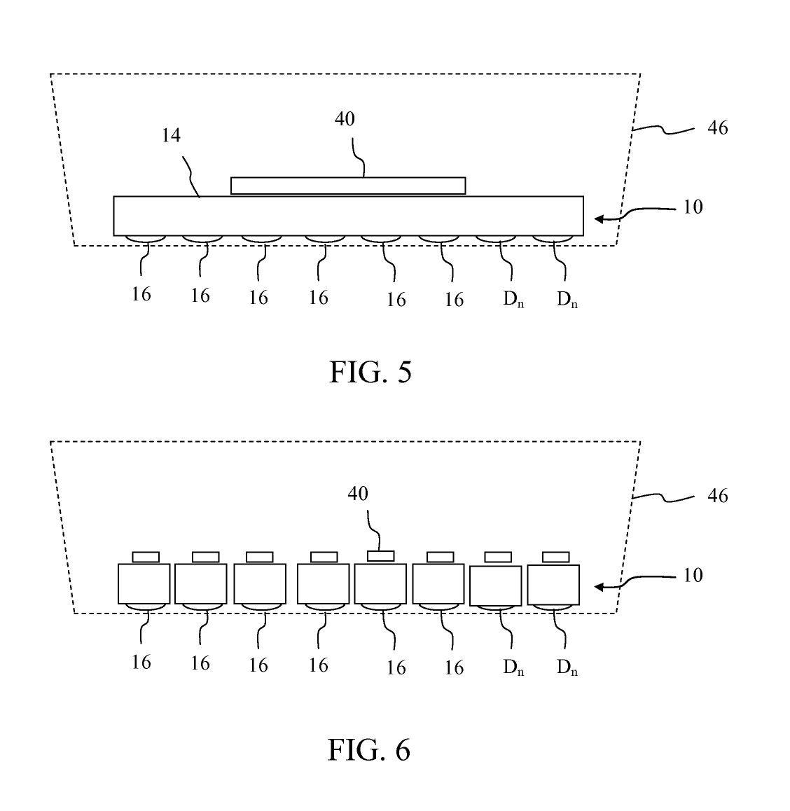

As will be understood from FIGS. 3, 4, 5, and 6, the trunk lid 46 comprising generally an upper flat portion 46a (partially shown) and a rear bent portion 46b. As seen from FIG. 3, the rear bent portion 46b has a tongue-like structure which extends downward from the upper flat portion 46a.

Referring back to FIG. 3, when the trunk lid 46 is in a closed position as shown, a trailing end 46b′ of the rear bent portion 46b is positioned just above a rear bumper 56 which is secured to a rear end of the associated vehicle 44 (trunk lid locking mechanism not shown). More specifically, the trunk lid 46 comprises an inner panel 48 and an outer panel 50 which are united to constitute a swelled lid structure 46, as shown. That is, an upper major portion of the inner panel 48 and the outer panel 50 constitute the upper flat portion 46a of the trunk lid 46, while a lower minor portion of the inner panel 48 and a rear bent portion 50′ of the outer panel 50 constitute the rear bent portion 46b of the lid 46. The leading end 46b′ of the rear bent potion 46b is constructed by folding back a terminal portion of the outer panel 50 over a terminal end of the inner panel 48, as shown.

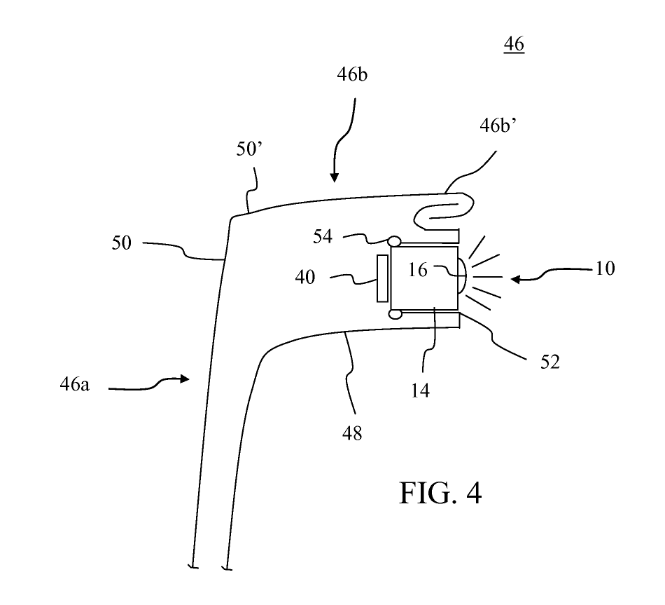

As seen in FIGS. 3 and 4, adjacent to the trailing end 46b′ of the rear bent portion 46b is a laterally extending slot 52. An inwardly projected edge of the laterally extending slot 52 is equipped therearound with an endless sealing thread 54 which is constructed of foamed rubber or the like. The multiple color hazard warning/signaling device for trailing end of trunk lid 10 is received in the laterally extended slot 52. Due to provision of the endless sealing thread 54 around the inwardly projected edge of the slot 52, sealing is assured between the multiple color hazard warning/signaling device for trailing end of trunk lid 10 and the slot 52. It can be appreciated by those skilled in the art that the area adjacent to the trailing end 46b′ may also serve as the housing for the multiple color hazard warning/signaling device for trailing end of trunk lid 10 without affecting the scope of the present invention. The housing 14 of the multiple color hazard warning/signaling device for trailing end of trunk lid 10 has an attachment means 40 for securing the multiple color hazard warning/signaling device for trailing end of trunk lid 10 within, or adjacent to, the trailing end of the trunk lid, said attachment means comprising, for example, an adhesive, magnet clips, clamps, pegs, hook and loop fasteners, screw fasteners, rivets, straps, springs, brackets, suction cups, or the like. FIGS. 3, 4, 5, and 6.

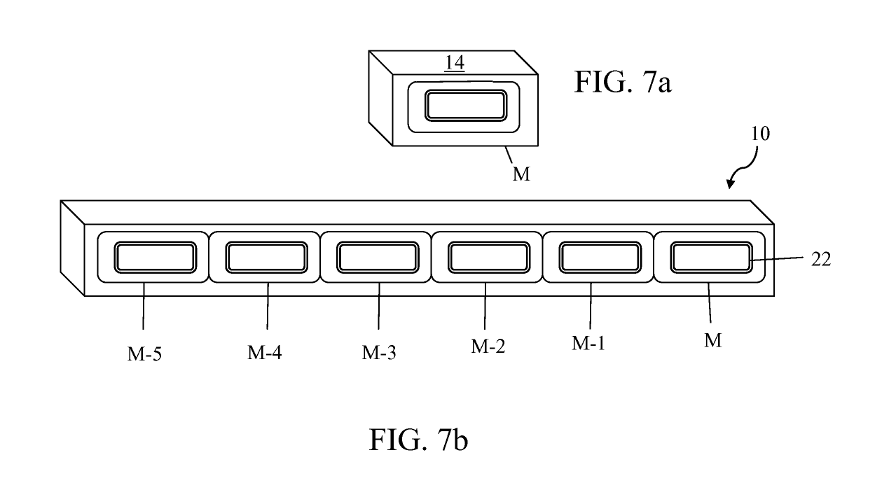

Depending on the curvature of the trunk lid of the vehicle 44, modules or light heads (M, M-1, M-2 . . . M-5) may not necessarily be coplanar. For example, the modules may be staggered to accommodate the curvature of the trailing end of the trunk lid (i.e., M is closer to the rear quarter panel than M-2 and so on). On the other hand, the modules may be substantially coplanar in a multiple color hazard warning/signaling device for trailing end of trunk lid 10. FIG. 7b.

The modules M are transparent, clear, or colored and are substantially equally positioned adjacent to each other along the length of the housing 14. FIGS. 7a and 7b. The housing 14 of the multiple color hazard warning/signaling device for trailing end of trunk lid 10 is a single housing with a plurality of modules (M, M-1, M-2 . . . M-5). Of course, the number of modules within the housing 14 may vary depending on the type of application and the mounting options for the multiple color hazard warning/signaling device for trailing end of trunk lid 10 in a particular vehicle. FIGS. 6, 7a, and 7b. Therefore, the multiple color hazard warning/signaling device for trailing end of trunk lid 10 can comprise multiple housings, each having a single module M. Also, the modules M may take on any shape, such as an oval, square, rectangle, or the like, and are not limited to the shape depicted in the drawings.

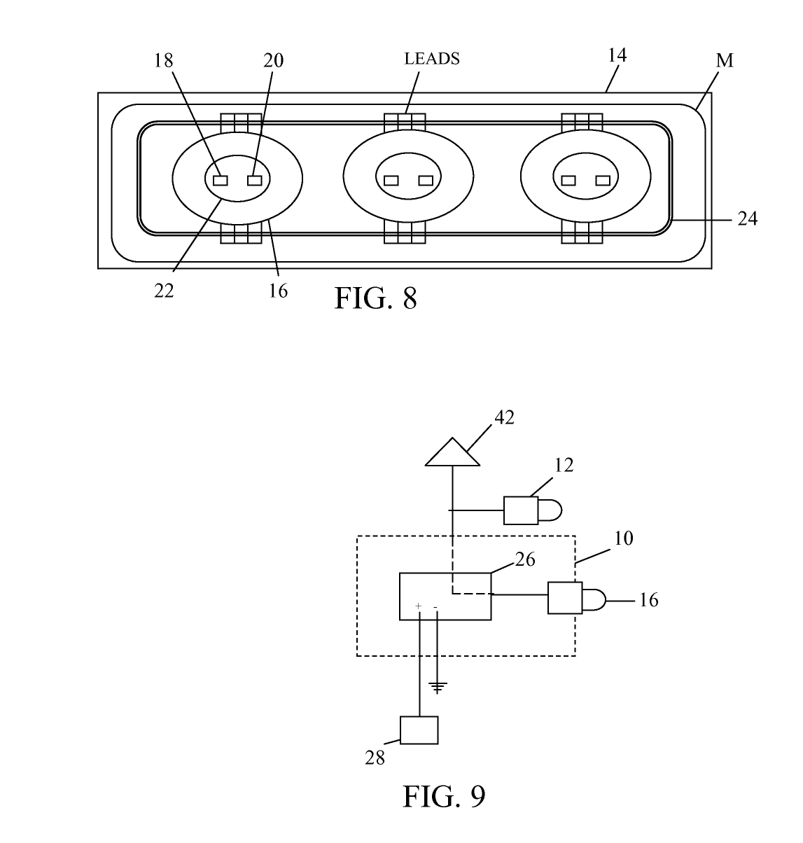

Each module M includes a plurality of LED packages 16 and a secondary optic lens 24, which is typically used with high powered LEDs to narrow down the angle of light output and project the light outwards (similar to a flashlight). FIG. 8. In this embodiment, there is one LED package 16 positioned within the module M. However, it should be appreciated that a greater number of LED packages 16 may be positioned within each module M depending on the size and particular application for the multiple color hazard warning/signaling device for trailing end of trunk lid 10 without departing from the scope of the present invention.

Each LED package 16 includes an individual diode D, two emitting chips 18, 20, a set of leads connecting the individual diode D to the light emitting chips 18, 20 and a primary optical lens 22. FIG. 8. The LED packages 16 as well as the individual diodes are aligned side-by-side creating a single row within the particular module. Importantly, each individual diode in the LED package 16 will produce a light in a first color and a second color when properly biased. To appropriately bias the individual diode, a drive signal from one of the pair of LED chips 18, 20 within each LED package 16 is sent through certain leads to trigger the individual diode to produce the following two color combination: red/amber. In other words, one of the chips corresponds to the first color (i.e., the left chip=red) and the other of the chips corresponds to the second color (i.e., the right chip=amber). Of course, the LED package 16 of the multiple color hazard warning/signaling device for trailing end of trunk lid 10 can also employ a single color LED or a multiple color LED instead of a bi-color LED without departing from the scope of the present invention.

The light emitting chips 18, 20 drive the color of the individual diode within the LED package 16 through the set of leads. In the past, the only way to produce two colors was to have two diodes. In this case, the individual diodes are driven by the light emitting chips 18, 20 to produce the desired different colors. Specifically, the individual diode emits either red or amber through the primary optical lens 22. The light output generated by the individual diode is projected through the primary optical lens 22 creating an optical illusion that there is a single LED that is actually changing color.

The LED packages 16 are situated in electrical communication with an operating device or controller 26 capable of selectively activating the LED packages 16 in the multiple color hazard warning/signaling device for trailing end of trunk lid 10. FIG. 9. Preferably, the operating device or controller 26 is mounted within the multiple color hazard warning/signaling device for trailing end of trunk lid 10. Alternatively, the operating device or controller 26 may be incorporated into the control system of vehicle 44, without affecting the scope of the present invention. Activation occurs upon application of a digital signal (Logic 0 or Logic 1) generated from a power source 28. Also, the operating device or controller 26 includes circuitry and is electrically connected to the LED packages 16 through a cable (not shown). The operating device or controller 26 could be a microprocessor, ASIC, collection of chips capable of performing functions or the like.

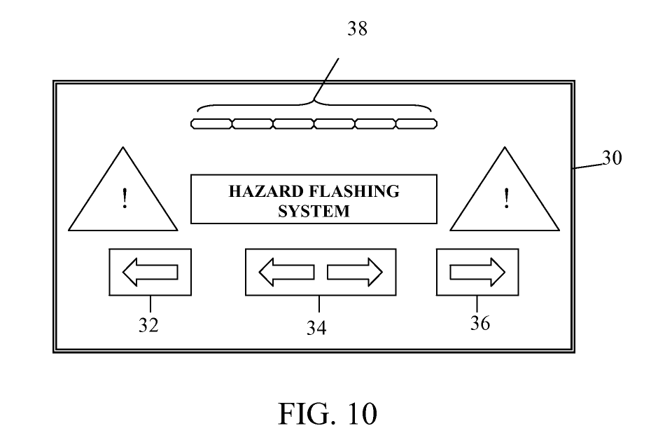

In addition, an optional LED indicator input device 30 for use in conjunction with the multiple color hazard warning/signaling device for trailing end of trunk lid 10 is illustrated in FIG. 10. The input device 30 is in electronic communication with the operating device or controller 26. The input device 30 is capable of being mounted within the same vehicle that the multiple color hazard warning/signaling device for trailing end of trunk lid 10 is mounted. In one embodiment, the input device 30 may be mounted near the operator's seat, such as within a center console, or in another embodiment, may be a liquid crystal display (LCD) monitor in the interior of the vehicle and mounted within a dashboard such that the operator may easily access the input device 30. The multifunctional multiple color center high mounted stop lamp 10 described herein is not required to be operated by the input device 30. Instead, it may be operated by other input devices or switch control systems as long as there are sufficient control/trigger wires and switches to accomplish the functions described herein.

The input device 30 includes a touch screen display and a plurality of user input buttons 32, 34, and 36 for activating various signal modes discussed above. FIG. 10. Each button corresponds to a specific pattern: 32 left directional arrows; 34 center-out directional arrows; 36 right directional arrows. The input device 30 is connected to a hazard flasher system button 42, signal indicators 12 and LED packages 16 of the multiple color hazard warning/signaling device for trailing end of trunk lid 10 via the cable. The normally-on brake lights 58 may also be connected to the input device 30 to become animated for purposes of added warning capabilities without departing from the scope of the present invention.

During use, once the operator of the vehicle reaches his destination, he/she may select the desired flash pattern by pushing one of the buttons on the input device 30. The input device 30 will display the same pattern on a plurality of LEDs 38 on the LCD monitor as the multiple color hazard warning/signaling device for trailing end of trunk lid 10. In order to select any arrow pattern, the operator initially selects/pushes the hazard flashing system button 42 to activate the hazard flasher system and then selects/pushes the desired traffic function button (i.e. 32 for left directional arrow; 34 for center-out directional arrows; or 36 for right directional arrow) which becomes displayed on the LCD monitor. The input device 30 and multiple color hazard warning/signaling device for trailing end of trunk lid 10 may be programmed such that when any arrow function is selected by the operator, warning/emergency mode or traffic directional mode automatically flashes red LEDs also.

Once the operator selects the particular application he/she wants the multiple color hazard warning/signaling device for trailing end of trunk lid 10 to perform by pushing the desired input button on the input device 30, a signal is sent to the operating device or controller 26. In turn, the operating device or controller 26 activates the particular light emitting chip 18, 20 (either red or amber) embedded in the LED package 16 to drive the desired color for the individual diode. In this manner, the multiple color hazard warning/signaling device for trailing end of trunk lid 10 is capable of producing multiple colors and patterns through the single optical lens 22.

In the traffic directional mode, the LEDs of the housing 14 of the multiple color hazard warning/signaling device for trailing end of trunk lid 10 display amber in various patterns depending on the traffic situation, including left, right and center-out directional signals. For example, when the vehicle is involved in a traffic accident or is broken down in the right lane of traffic, the driver may desire to direct other drivers to clear the right lane and use the left lane(s) of the road/highway or vice-versa if the accident or vehicle is in the left lane. In addition, if there is a multiple-lane highway and the vehicle obstructs the middle lane, it may be desirous to use the center-out directional mode.

In left directional signal mode corresponding to input button 32, the LEDs in module M of the housing 14 display amber, followed by the LEDs in the second module M-1, followed by the LEDs in the third module M-2 and so on until all six modules (M through M-5) display amber. This pattern is repeated until the left directional signal mode is turned OFF or changed to another mode. It takes about 0.6 seconds for all of the modules to display amber, so there is approximately 0.1 seconds time lapse between the first module displaying amber and then the second module displaying amber and so on. It should be appreciated that the timing and type of pattern may be adjusted to varying lengths and patterns.

Similarly, in right directional signal mode corresponding to input button 36, the LEDs in module M-5 of the housing 14 displays amber, followed by the LEDs in the fifth module M-4, followed by the LEDs in the fourth module M-3, and so on until all six modules (M-5 through M) display amber. This pattern is repeated until the right directional signal mode is turned OFF or changed to another mode. Additionally, in the center-out directional mode corresponding to input button 34, LEDs in module M-2 and the LEDs in module M-3 display amber simultaneously, followed by the LEDs in module M-1 and the LEDs in module M-4 and so on until all of the modules are displaying amber. This pattern is repeated until the center-out directional mode is turned off or changed to a different mode.

In the embodiments detailed above, the LED packages 16 includes the first chip 18 that corresponds to the color red and the second chip 20 that corresponds to the color amber. This, the multiple color hazard warning/signaling device for trailing end of trunk lid 10 is able to display a red flashing pattern. Moreover, due to the presence of the second chips corresponding to the color amber, the multiple color hazard warning/signaling device for trailing end of trunk lid 10 is also able to display amber. Of course, it can be appreciated by those skilled in the art that the light emitting chips 18, 20 that drive the color of the individual diode within the LED package 16 through the sets of leads are not limited to the colors red and/or amber, but may also drive other colors, such as white and/or blue, for example, without departing form the scope of the present invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention.

Having thus described the invention, what is claimed as being new and desired to be protected by Letters Patent of the United States is as follows:

1. A rear opening fixture of a vehicle comprising:
A hazard warning/signaling device for trailing end of trunk lid comprising a plurality of light emitting diodes aligned in a single row, each of the plurality of light emitting diodes configured to emit two different colors of light; and
an operating device or controller,

2. The hazard warning/signaling device for trailing end of trunk lid of claim 1, wherein said hazard warning/signaling device for trailing end of trunk lid is capable of producing a single color pattern and/or a dual color pattern.

3. The rear opening fixture according to claim 1 wherein said rear opening fixture is selected form the group consisting of a trunk lid, hatch door, tailgate and roof area of the vehicle.

4. The hazard warning/signaling device for trailing end of trunk lid of claim 1, further comprising a housing.

5. The hazard warning/signaling device for trailing end of trunk lid of claim 4, further comprising a plurality of modules positioned within the housing.

6. The hazard warning/signaling device for trailing end of trunk lid of claim 5, wherein the plurality of modules are equally positioned adjacent from each other along the length of the housing.

7. The hazard warning/signaling device for trailing end of trunk lid of claim 4, wherein said housing has an attachment means for securing said device within, or adjacent to, the trailing end of said rear opening fixture of said vehicle, said attachment means comprising, for example, an adhesive, magnet clips, clamps, pegs, hook and loop fasteners, screw fasteners, rivets, straps, springs, brackets, suction cups, or the like.

8. The hazard warning/signaling device for trailing end of trunk lid of claim 5, wherein each of the plurality of modules includes a secondary optic lens covering all of the plurality of light emitting diodes in each of said plurality of modules.

9. The hazard warning/signaling device for trailing end of trunk lid of claim 5, further comprising a plurality of light emitting diodes packages located in each of the plurality of modules.

10. The hazard warning/signaling device for trailing end of trunk lid of claim 9, wherein the plurality of light emitting diode packages correspond equally to each of the plurality of light emitting diodes.

11. The hazard warning/signaling device for trailing end of trunk lid of claim 9, wherein each of the plurality of light emitting diode packages includes a pair of light emitting chips corresponding equally to each of the plurality of light emitting diodes.

12. The hazard warning/signaling device for trailing end of trunk lid of claim 11, wherein a first one of the pair of light emitting chips configured to provide a red color to the corresponding one of the light emitting diodes.

13. The hazard warning/signaling device for trailing end of trunk lid of claim 11, wherein a second one of the pair of light emitting chips configured to provide an amber color to the corresponding one of the light emitting diodes.

14. The hazard warning/signaling device for trailing end of trunk lid of claim 8, wherein each of the plurality of light emitting diode packages includes a primary optical lens.

15. The hazard warning/signaling device for trailing end of trunk lid of claim 1, further comprising an operating device or controller in electric communication with each of the plurality of light emitting diodes.

16. The hazard warning/signaling device for trailing end of trunk lid of claim 1, further comprising an input device having multiple user input buttons for selecting a desired pattern.

17. A hazard warning/signaling device for trailing end of trunk lid for a vehicle, said hazard warning/signaling device for trailing end of trunk lid comprising:
a housing including a plurality of modules, each of the plurality of modules having at least two light emitting diode packages;
each of the at least two light emitting diode packages including a pair of light emitting chips connecting to a single light emitting diode;
each of the single light emitting diodes are aligned in a single row and configured to emit two different colors of light upon receipt of a signal from the pair of light emitting chips,
whereby the hazard warning/signaling device for trailing end of trunk lid is capable of producing a single color light pattern and a dual color light pattern.
